(19) United States
(12) Patent Application Publication
(10) Pub. No.: US 2025/0191499 A1
(43) Pub. Date: Jun. 12, 2025

(54) Method for Integrated 3D Printing of Articulated Models with Preserved Spatial Kinematics and Functional Movement

(71) Applicant: Ricardo Vega, Panama (PA)

(72) Inventor: Ricardo Vega, Panama (PA)

(21) Appl. No.: 18/532,536

(22) Filed: Dec. 7, 2023

(51) Int. Cl. G09B 23/32; B33Y 10/00; B33Y 80/00

(52) U.S. Cl. CPC G09B 23/32; B33Y 10/00; B33Y 80/00

(57) ABSTRACT

The present invention in some embodiments thereof, discloses methods for maintaining accurate spatial positioning of 3D printed anatomical components by utilizing temporary printed connectors between objects or flexible fill material between gaps. This enables proper anatomical alignment when printing parts independently on a structure or support, then assembling into complete models. After applying a sealer/paste/glue/sticky substance/flexible substrate that will maintain the position of the printed anatomical components, the printed connections may be broken to create movable joints while retaining accurate anatomy. This allows 3D printing of multi-part medical replicas like bone and joint structures with natural articulation. The disclosed teaching is useful for surgical simulation models in medical education and pre-surgical planning. It improves anatomical accuracy of customizable 3D printed body part models compared to conventional methods and provides training experience superior to current rigid anatomical replicas.

### FIELD OF INVENTION

The field of invention relates to the field of 3D printing articulated models, specifically methods for accurately maintaining the spatial positioning of individually printed components to recreate complex multi-part structures that require precise alignment, while still allowing flexible movement between the components.

### BACKGROUND OF THE INVENTION

Historically, medical training involved direct work with cadavers to gain an intricate understanding of human anatomy. However, cadavers have always been difficult to obtain. This led to the development of anatomical models for teaching, beginning with primitive wax and wooden models in the 16th century.

In the 20th century, plastic anatomical models became widely used, providing more detail than previous training tools but still limited in their ability to represent joint mechanics and surgical feel. With the advent of 3D printing technology in the 1980s, anatomic models with higher degrees of accuracy and customization became possible.

3D printed models now play a major role in medical education and pre-surgical planning. They provide unique hands-on experience and help trainees develop surgical skills without risk to patients. However, a remaining challenge is printing models that require assembly of multiple components while retaining the proper spatial relationships and joint articulation.

Errors in positioning of bones and joints limit the utility of current 3D printed anatomical models. The present invention aims to solve this problem through novel techniques for maintaining anatomical accuracy of complex 3D printed structures. By utilizing temporary printed connectors or flexible fill between components, the invention enables proper anatomical alignment of individually printed parts, overcoming a key limitation of current medical training models.

The invention has the potential to significantly enhance 3D printing of customizable anatomical replicas for surgical simulation and medical education, increasing healthcare providers' preparedness and improving patient outcomes and limb prostheses. Additionally, it can be relevant in automobile industry, electric components, toys, etc. It can be a breakthrough for 3d printing mass production.

### SUMMARY OF THE INVENTION

The following summary is an explanation of some of the general inventive steps for the system, method, devices and apparatus in the description. This summary is not an extensive overview of the invention and does not intend to limit its scope beyond what is described and claimed as a summary.

Embodiments of the present disclosure may disclose novel methods for maintaining accurate spatial positioning of 3D printed anatomical components by utilizing temporary printed connectors or flexible fill material between separately printed parts. This enables proper anatomical alignment when printing components independently then assembling into complete models.

The parts may be printed during a single 3d printing job or multiple printing jobs. They may be printed with a connector structure that will be responsible of maintaining the initial position prior to the application of the flexible material.

In one embodiment, small breakaway structures may be designed to be printed between the bones. The structures are preferably thin and breakable. They may help securing the correct position of the objects during the entire process until the end where they are broken with a manual bending motion.

In an alternative embodiment, the components are printed with gaps between them. The gaps are then filled with a flexible paste, glue, or sealant material to create flexible joints between the components. The fill material adheres to the components, keeping them in the proper alignment while allowing articulation at the joints.

The fill material may be inserted using syringes, tubes, or other delivery methods. The material cures to a flexible state that allows repetitive motion of the joints while maintaining original positioning. Different fill materials can be used to tune joint stiffness and mimic ligaments, tendons, and cartilage.

In one embodiment, the support structure or mold is generated through software and digitally holds the individual components in their proper anatomical arrangement during the printing process before being dissolved or removed. The small printed connectors between components may be kept in place until the model is ready for shipment or use, helping retain spatial positioning.

The present invention enables integrated 3D printing of articulated anatomical models that preserve the spatial kinematics and functional movements of real-life joints and structures. Rather than printing and assembling components separately, the techniques allow seamless printing of multiple connected parts with life-like articulation. The models maintain accurate spatial relationships in terms of 3D proximity and range of motion based on source imaging and data. Critical joints can be printed with flexible fill or breakaway supports to create assemblies that move realistically for their intended function, whether simulating body joints or mechanical systems.

In one example for an articulated foot model, small connectors are digitally designed and 3D printed between toe bones and metatarsals. Leaving out these connectors would allow independent toe movement but cause defects when applying the outer skin layer digitally or physically. The connectors help secure relative positioning in the tight confines of the anatomy, ensuring articulate function within a fully integrated printed model.

This technique can be used to print full anatomical replicas such as foot and ankle assemblies. The bones, muscle blocks, ligaments, and skin layers may be printed or attached separately based on medical scans. Breakaway supports or flexible fill maintains spatial relationships between components. In some aspects, connectors may be used with the flexible fill.

In an alternative embodiment, a molten thermoplastic or other flexible material with a low melting point is used as the connecting material injected between components. After assembling printed bones or other structures into their proper anatomical arrangement, the molten material may be applied into the gaps and allowed to cool. Upon solidifying, the material forms flexible joints to allow articulation while retaining the spatial positioning. For example, a melted flexible plastic such as polycaprolactone can be inserted in a liquid state then hardens at room temperature into an elastomeric bridge. Using this flexible material strategy eliminates curing time and enables quicker assembly of articulating models with seamless bonded components.

Alternative embodiments may apply this technique to other anatomical regions, such as hands, limbs, spine, and joints. The models provide high physical accuracy and realistic motion for surgical simulation and medical device testing. Patient-specific models can be created for pre-surgical planning using the subject's scan data.

The disclosed methods enable 3D printing of detailed customizable anatomical replicas not previously feasible. The models open opportunities for advanced simulation in medical education, device development, and telemedicine applications dependent on realistic physical models.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 shows a foot assembly according to one aspect.

FIG. 2 illustrates a foot and ankle assembly on a supporting structure according to one aspect.

FIG. 3 depicts an attachment of support structure to a foot assembly according to one aspect.

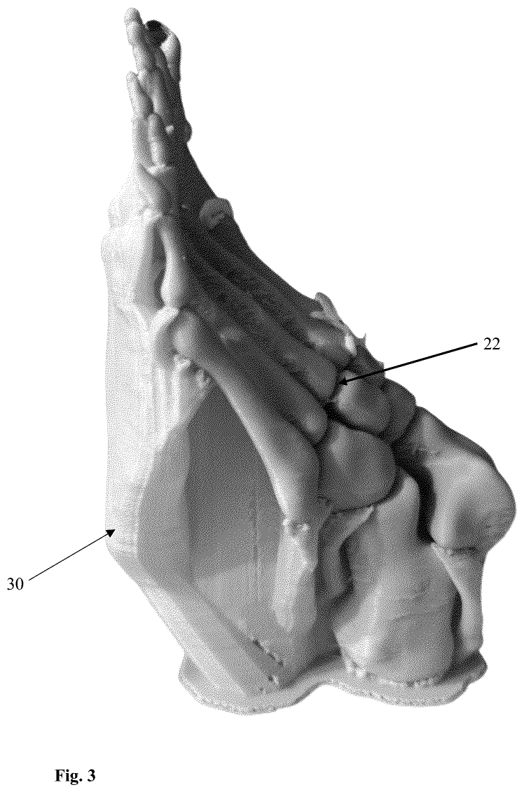

FIG. 4 is an illustration of gaps between printed bones filled with a flexible paste, glue, or sealant material according to one aspect.

FIG. 5 is an illustration of a foot and ankle assembly with a wire or needle or anything keeping the object positioned for joining with the paste according to another aspect.

FIG. 6 is an illustration of a foot and ankle assembly with a wire or needle or anything keeping the object positioned for joining with the paste according to another aspect.

FIG. 7 is an illustration of a foot and ankle assembly with a wire or needle or anything keeping the object positioned for joining with the paste according to another aspect.

FIG. 8 is an illustration of a foot and ankle assembly with a wire or needle or anything keeping the object positioned for joining with the paste according to another aspect.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

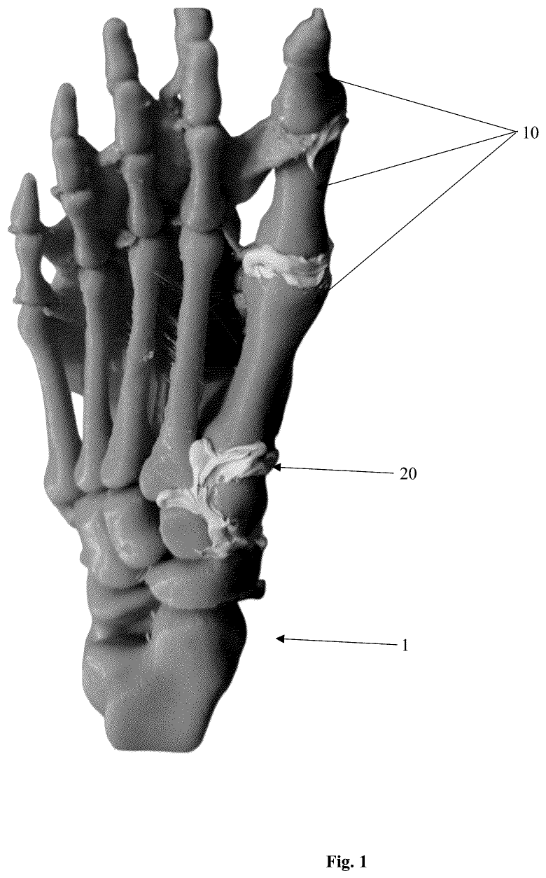

Referring to FIG. 1, it is illustrated an embodiment of the invention for maintaining anatomical positioning of a 3D printed foot assembly 1 bone components printed at the same time but with empty space or small unions between them 10. In one aspect, the bones 10 have been printed at the same time and the position is initially secured with a support structure automatically generated by the slicing software. Gaps are present between the adjacent bone components that require accurate spatial positioning, such as the ankle bones, tarsal bones, metatarsals, and phalanges that make up the full foot skeleton.

To maintain the proper positioning of the bones 10, a flexible paste material 20 has been injected into the gaps between the components after printing. This paste 20 acts as an elastic filler that adheres to the bones 10, keeping them in the correct anatomical alignment while still permitting flexibility at the joints, which further allows them to be spread superficially.

The paste 20 may be inserted by syringe through holes in the bones 10 or other entry points. Once cured, the paste 20 allows repetitive motion of the joint while retaining the original spatial relationships of the bones 10. The paste material 20 properties can be tuned to mimic ligament and cartilage stiffness.

The embodiment of FIG. 1 demonstrates the use of flexible fill material between 3D printed components to create an articulating foot model with high anatomical fidelity. The methods enable printing complex assemblies from individual parts while retaining proper spatial relationships for surgical simulation. On the figure, where phalanges can be seen, it is also shown the small and breakable unions that may preferably be designed prior to the print job.

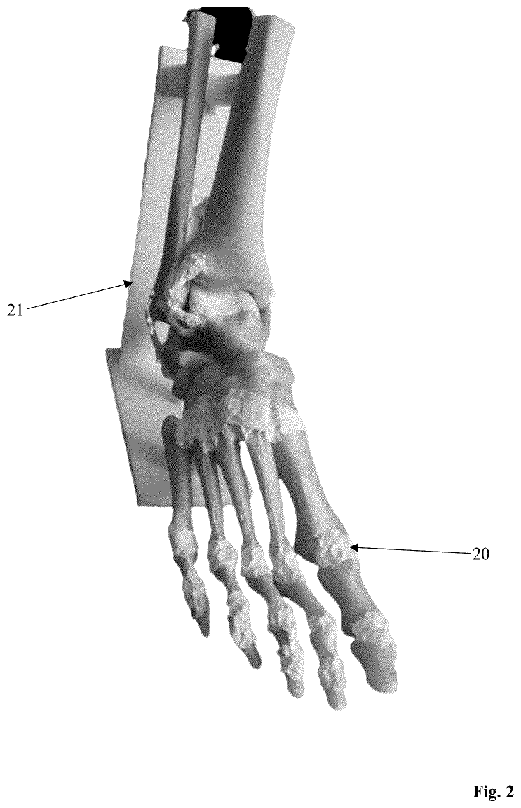

The embodiment according to FIG. 2 illustrates using a supporting structure 21 to maintain positioning of a 3D printed foot and ankle assembly during the printing and assembly process.

The various foot and ankle bones 10 have been printed separately onto the surface of the structure 21, which holds them in the proper anatomical arrangement as the printing is performed. The structure 21 has a shape matching the shape of the structure assembled from the individual bones to secure them in the accurate positions.

Once all the bone components are printed onto the structure 21, a flexible paste material 20 is injected into the gaps between the bones. As in FIG. 1, this paste 20 adheres to the bone surfaces, keeping them in the correct spatial alignment after the printed assembly is removed from the structure 21.

The paste 20 cures to form flexible joints between the bones 10, retaining their anatomical positions while enabling natural articulation at the joint interfaces. Different paste materials can be used to achieve the desired joint mechanical properties, and may include liquid or filament.

As such, the supporting structure technique ensures accurate bone positioning during printing by providing a template that holds each component in place. The subsequent flexible paste connections allow full foot/ankle motion. This embodiment enables printing of intricate anatomy not feasible with conventional unitary 3D prints.

Once printing is complete, and issue material 30 is applied, the connector may be broken with light force, separating the bones while retaining their spatial relationships. The foot assembly maintains its accurate anatomy while enabling free articulation at the joints.

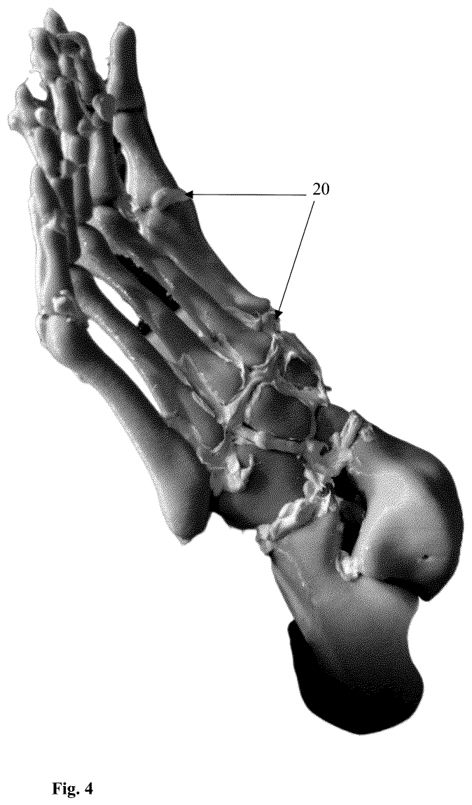

On the other hand, FIG. 4 is an illustration of gaps between printed bones filled with a flexible paste, glue, or sealant material according to one aspect. As shown, the individual bones of the foot have been printed separately with gaps remaining between them. These gaps are then filled with a flexible paste, glue, or sealant material 20. The fill material 20 adheres to the surfaces of the adjacent bones, keeping them fixed in the proper spatial alignment. Once cured, the fill material 20 between the bones forms flexible joints that allow natural articulation of the foot assembly. The material composition is selected to provide joint mechanics that mimic real ligament and cartilage properties. This enables realistic motion while retaining accurate positional relationships between the printed bones.

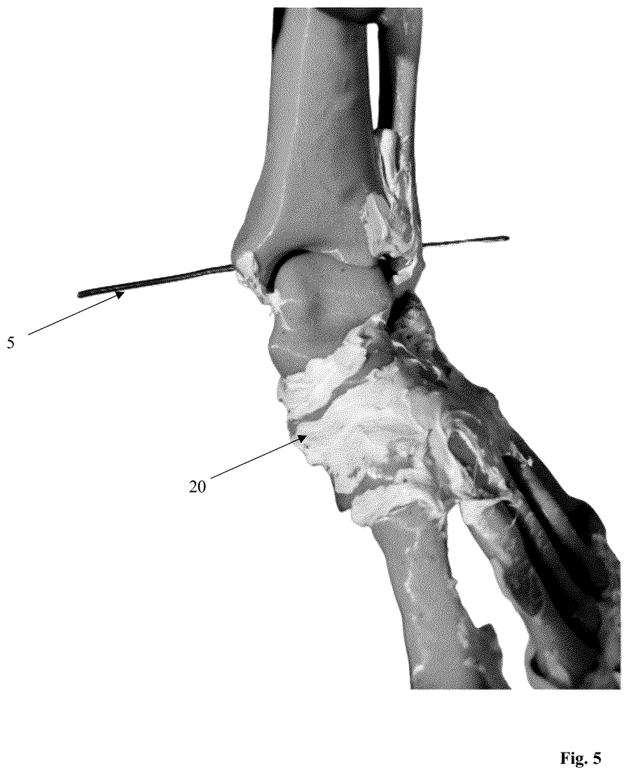

Yet in another embodiment, FIG. 5 illustrates an alternative mechanism using a positioning wire or needle 5 to secure the alignment of bones in a foot and ankle assembly before applying a flexible fill paste. As shown, the individual bone components have been printed separately and assembled into the proper anatomical arrangement. However, gaps exist between the bones that require a method to keep them in position.

To address this, a thin wire, needle, or other similar object 5 has been inserted through holes in the bones to hold them in the proper spatial alignment. This wire 5 acts as a temporary fastener to prevent movement of the bones while allowing the assembly to be handled. In an alternative aspect, the wire path may be designed before the print job and it is placed through the talus the fibula and the tibia on the correct mechanical axis to allow full motion of the ankle after the flexible material is placed and the wire is removed.

Once the bone assembly is secured in position by the wire or needle 5, a flexible paste can be injected into the gaps between the components. As described in previous embodiments, this paste adheres to the bones, keeping them in the correct positions after the wire 5 is removed. The positioning wire or needle 5 provides temporary alignment while the paste provides permanent flexible connections.

In some aspects, the small bones may be printed at the same time during a single printing job, while the bigger bones such as tibia and fibula are printed separately. For example, foot and ankle may be printed separately, whereby the foot and tibia/fibula position is kept together using a predefined hole through which a wire or a needle is passed maintaining the real position.

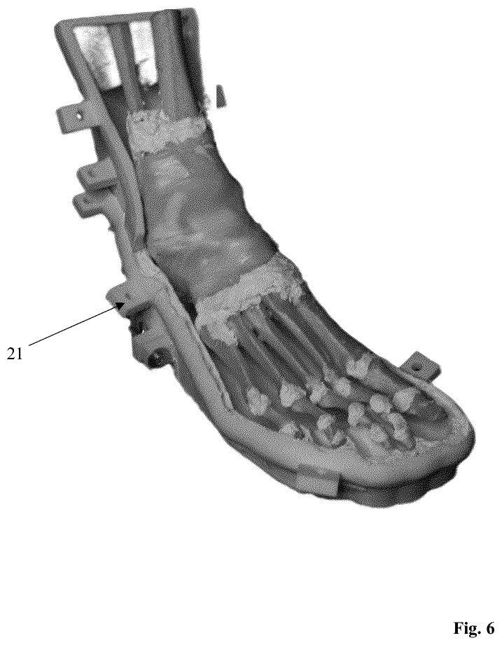

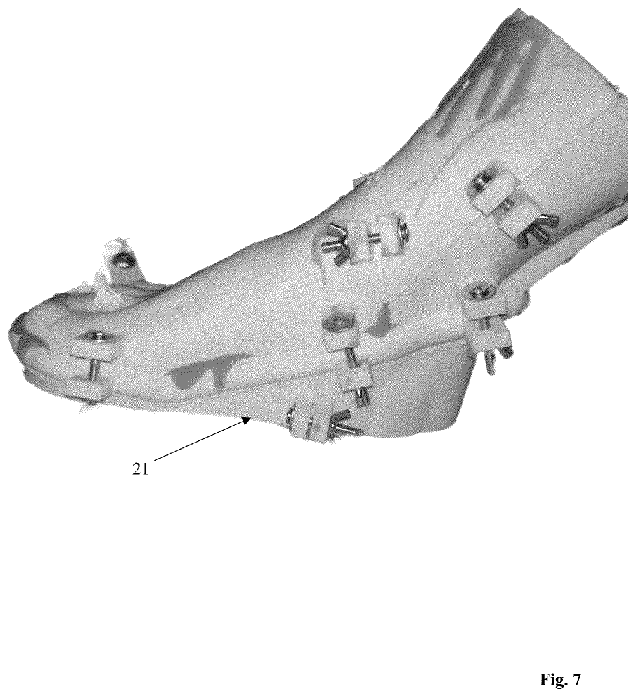

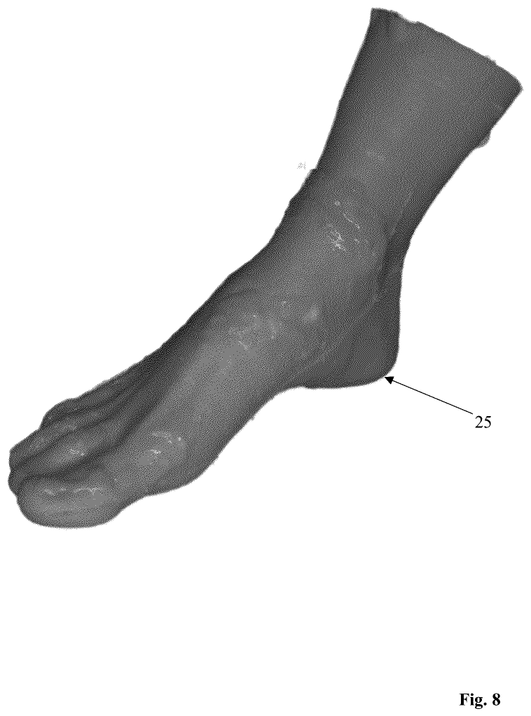

In embodiments illustrated in FIG. 6, FIG. 7 and FIG. 8 illustrate some of the final preparation steps. Beginning with FIG. 6, it is shown the structure prepared and then the bones are also shown printed and preferably secured in position to the structure by the use of adhesive elastic paste. In some aspects, the bones may be secured to the structure needles or wires used to keep the bones centered to avoid contact with the walls of the structure.

On the FIG. 7 it is shown the prepared structure 21, preferably printed by a 3D printing device, or by casting or some other process enclosed the printed bones therein. A suitable foaming agent is then poured into the enclosed structure to surround the printed bones. In some aspects, it may be necessary to apply a silicone material to the inner surface of the structure to prevent the printed bones or foaming agent from adhering to the walls of the structure. The FIG. 8 shows the final product 25 after the structure is removed.

In some aspects, there may be holes can be designed through the structures to pass needles or wires keeping the structure centered and allowing an anatomically correct position that is exactly the same as the skin such that when one touches a bone prominence on the skin they will have a feel of the corresponding bone.

In one non-limiting embodiment, applying a tissue layer as disclosed herein comprises encapsulating the assembled components with a polymer foam or other flexible material to simulate soft tissue.

In another non-limiting embodiment, the method of applying a tissue layer disclosed herein further comprises tuning the properties of the flexible fill material to achieve desired joint stiffness for mimicking cartilage, tendons, or ligaments.

In another embodiment, the flexible fill material may be applied with a robotic tool such as the 3d printer extruder arm, a dispenser system or using curated flexible resins chemical or by the use of photopolymerization.

In an additional non-limiting embodiment, the method of applying a tissue layer disclosed herein further comprises using CT, MRI, or other scan data to print components modeled on a subject's specific anatomy.

In another non-limiting embodiment, the anatomical components disclosed herein comprise bones of the foot and ankle for surgical simulation and training.

Although preferred embodiments of the present invention have been described for illustrative purposes, those skilled in the art will appreciate that various modifications, additions and substitutions are possible, without departing from the scope and spirit of the invention as disclosed in the accompanying claims and detailed description.

For example, the specific materials used for the printed temporary connectors or flexible fill can be varied while still providing the required positioning and articulation functions. The technique can be applied to anatomical models other than the foot and ankle. The process can be adapted to different 3D printing methods capable of printing temporary breakaway connectors.

Accordingly, the applicant intends to embrace all such alternatives, modifications, equivalents and variations that are within the spirit and scope of the disclosed subject matter. It should also be understood that references to components, materials or steps in the singular should be understood to include the plural, and vice versa, unless explicitly stated otherwise or clearly from the context. Grammatical conjunctions are intended to express any and all disjunctive and conjunctive combinations of conjoined clauses, sentences, phrases, and the like, unless otherwise stated or clear from the context. Thus, the term “or” should generally be understood to mean “and/or” and so forth.

### INDUSTRIAL APPLICATION

The present invention has significant industrial applicability in the medical sector, specifically for companies producing anatomical models and replicas for surgical simulation training and pre-operative planning. The disclosed techniques enable manufacturers to create highly accurate jointed mannequins that maintain proper spatial relationships between bones, muscles, and other structures. This allows creation of customizable, articulating body part models at scale for wide distribution and use at medical facilities. The jointed simulation mannequins produced using these methods provide unmatched realism in surgical rehearsal while avoiding the enormous costs of cadaver acquisition and maintenance. The industrial impact spans medical equipment companies, 3D printing services, educational institutions, surgical training centers, prosthetics, robotics, animatronics, toys, motor industry, electrical, and healthcare networks seeking to improve practitioner readiness and patient outcomes through advanced simulation technologies.

What is claimed is:

1. A method for producing an articulating anatomical model using flexible fill material, comprising:
separately printing individual anatomical components with gaps between the components;
assembling by the use of supporting structure the individual components in their proper anatomical arrangement;
injecting a flexible paste or sealant material into the gaps between the components; and
curing the flexible material to form flexible joints between the components, where the flexible joints maintain the spatial positioning of the components while enabling articulation.

2. The method according to claim 1, wherein the supporting structure comprises inserting a wire or needle temporarily through holes in the components to maintain their spatial positioning while injecting the flexible material.

3. The method according to claim 2, wherein a wire path may be developed before the printing, disposed on the support between the talus the fibula and the tibia on the correct mechanical axis to allow full motion of the ankle after the flexible material is placed and the wire is removed.

4. The method according to claim 1, further comprising printing the individual components onto a support structure or frame matching the shape of the assembled structure, to hold the components in proper anatomical arrangement during printing and assembly.

5. A method for producing an articulating anatomical model using breakaway supports, comprising:
printing individual anatomical components with small breakable supports connecting the components;
assembling the individual components together such that the supports hold the components in their proper anatomical arrangement;
applying a tissue layer over the assembled components; and
breaking the small supports between components with light force to allow articulation while retaining the anatomical alignment.

6. The method according to claim 5, wherein applying a tissue layer comprises encapsulating the assembled components with a polymer foam or other flexible material to simulate soft tissue.

7. The method according to claim 5, further comprising tuning the properties of the flexible fill material to achieve desired joint stiffness for mimicking cartilage, tendons, or ligaments.

8. The method according to claim 5, further comprising using CT, MRI, or other scan data to print components modeled on a subject's specific anatomy.

9. The method according to claim 5, wherein the anatomical components comprise bones of the foot and ankle for surgical simulation and training.

10. An articulating anatomical model comprising:
a plurality of separately printed anatomical components assembled together in their correct anatomical arrangement on a structure; and
a flexible fill material between the components bonding them together while allowing articulation.

11. The anatomical model of claim 10, wherein the flexible fill material comprises a paste, glue, or sealant that adheres to the components.

12. The anatomical model of claim 10, further comprising a layer of polymer foam or flexible material encapsulating the components to simulate soft tissue.

13. The anatomical model of claim 12, wherein the flexible fill material has tunable mechanical properties to mimic joint stiffness and mechanics.

14. The anatomical model of claim 10, wherein the components are based on CT, MRI, or scan data from a subject.

15. The anatomical model of claim 10, wherein the components comprise foot and ankle bones.

16. The anatomical model of claim 10, wherein the components are printed with small breakable supports connecting the components.
